(19) United States
(12) Patent Application Publication
(10) Pub. No.: US 2019/0029195 A1
(43) Pub. Date: Jan. 31, 2019

(54) Flowerpot with Water Conservation Arrangement

(71) Applicant: Li-Yuan LI, Azusa, CA (US)

(72) Inventor: Li-Yuan LI, Azusa, CA (US)

(21) Appl. No.: 15/665,316

(22) Filed: Jul. 31, 2017

(51) Int. Cl. A01G 27/04; A01G 9/02

(52) U.S. Cl. CPC A01G 27/04; A01G 9/021

(57) ABSTRACT

A flowerpot includes a main body and a water conservation arrangement. The water conservation arrangement includes a plurality of ventilating holes formed on a lower portion of the main body, at least one through drainage hole formed on the main body, a control valve provided on the drainage hole, and a plurality of selective passage members attached on an inner surface of the main body to completely cover the ventilating holes respectively. Each of the selective passage members is configured to have a predetermined water permeability and a predetermined air permeability. When a predetermined amount of soil and water are disposed in the receiving cavity, the water is substantially conserved in the received cavity for being absorbed by the plant.

### BACKGROUND OF THE PRESENT INVENTION

### Field of Invention

The present invention relates to a pot, and more particularly to a flowerpot comprising a water conservation arrangement which is capable of substantially trapping water in the flowerpot for an extended period of time.

### Description of Related Arts

A conventional pot, such as a conventional flowerpot, usually comprises a pot body and a water collection basin. The pot body usually has a receiving cavity and a plurality of through holes formed on a bottom wall or a sidewall thereof. The pot body is usually disposed on the water collection basin which is responsible for temporarily collecting water draining from the receiving cavity.

In order to grow a plant in the flowerpot, a certain amount of soil must be disposed in the receiving cavity. A user must regularly pour water in the receiving cavity. A common problem of the above-mentioned traditional flowerpot is that when too much water is poured into the receiving cavity, a substantial amount of water will come out from the through holes and stay in the water collection basin. The water staying in the water collection basin will become still water and attract a substantial number of insects, especially mosquitos, to go near the flowerpot. These mosquitos have become a major health and hygiene issue throughout the United States. Because of this reason, some states even prohibit the use of water collection basins. However, in the absence of water collection basins, water coming out from the holes will be evaporated rapidly and cannot be reused and this has the effect of wasting a substantial amount of water.

Moreover, when too much water is lost through the holes of the flowerpot, the water remaining in the receiving cavity may not be enough to be absorbed by the plant. This is especially true when the weather is hot or the flowerpot is used in an environment in which the humidity is very low.

One might think that removing the holes from the flowerpot might resolve the above-mentioned problem because by not forming holes on the flowerpot, water will not come out from the holes and therefore will not be wasted. While this is true from the perspective of water conservation, allowing too much water to stay in the flowerpot will destroy the roots of the plant.

As a result, it is undesirable that there is either too less water or too much water in the flowerpot, yet conventional flowerpots such as those described above do not have any effective structure in preventing excessive water loss while at the same time preventing excessive water from staying in the flowerpot.

As a result, there is a need to develop a flowerpot which is capable of substantially trapping a suitable amount of water in the flowerpot for an extended period of time.

### SUMMARY OF THE PRESENT INVENTION

Certain variations of the present invention provide a flowerpot comprising a water conservation arrangement which is capable of substantially trapping water in the flowerpot for an extended period of time.

Certain variations of the present invention provide a flowerpot comprising a water conservation arrangement, wherein the flowerpot does not require the use of any water collection basin.

Certain variations of the present invention provide a flowerpot comprising a water conservation arrangement which is capable of allowing water to be slowly absorbed by the plant while at the same time preventing the plant from immersing in too much water.

In one aspect of the present invention, it provides a flowerpot for a plant, comprising:

a main body having a bottom wall, a sidewall upwardly extended from the bottom wall, a receiving cavity formed as a space surrounded by the bottom wall and the sidewall, and a top opening communicating the receiving cavity with an exterior of the main body; and

a water conservation arrangement, which comprises:

a plurality of ventilating holes formed on a lower portion of the main body;

at least one through drainage hole formed on the main body;

a control valve provided on the drainage hole for being selectively opened to drain water from the receiving cavity; and

a plurality of selective passage members attached on the main body to completely cover the ventilating holes respectively, each of the selective passage members being configured to have a predetermined water permeability and a predetermined air permeability,

wherein when a predetermined amount of soil and water are disposed in the receiving cavity, the water is substantially conserved in the received cavity for being absorbed by the plant.

In another aspect of the present invention, it provides a method of making a flowerpot, comprising the steps of:

(a) forming a main body having a receiving cavity, the main body having a bottom wall, a sidewall upwardly extended from the bottom wall, a receiving cavity formed as a space surrounded by the bottom wall and the sidewall, and a top opening communicating the receiving cavity with an exterior of the main body;

(b) forming a plurality of through ventilating holes on a lower portion of the main body;

(c) attaching a plurality of selective passage members on an inner side of the main body to cover the ventilating slots respectively;

(d) disposing a certain amount of weight members in the receiving cavity of the main body, a cumulative height of the weight members not exceeding a height of the highest ventilating slots; and

(e) disposing a selective passage member on top of the weight members.

This summary presented above is provided merely to introduce certain concepts and not to identify any key or essential features of the claimed subject matter.

### BRIEF DESCRIPTION OF THE DRAWINGS

FIG. 1 is an exploded perspective view of a flowerpot according to a preferred embodiment of the present invention.

FIG. 2 is a perspective view of a flowerpot according to the preferred embodiment of the present invention.

FIG. 3 is a side view of the flowerpot according to the preferred embodiment of the present invention.

FIG. 4 is a method of making the flowerpot according to the preferred embodiment of the present invention.

FIG. 5 is an alternative mode of the flowerpot according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

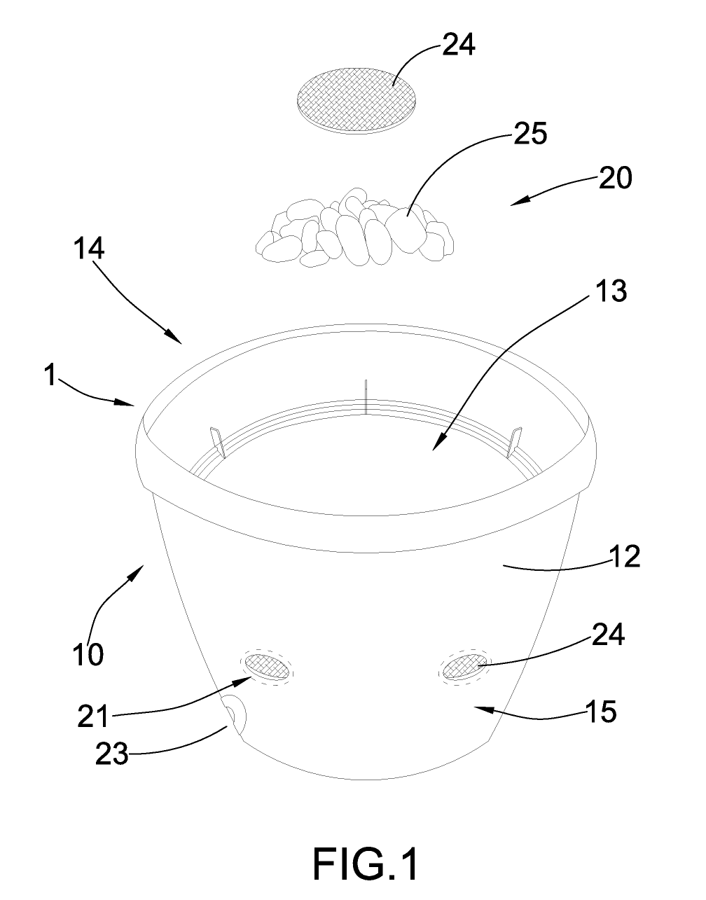

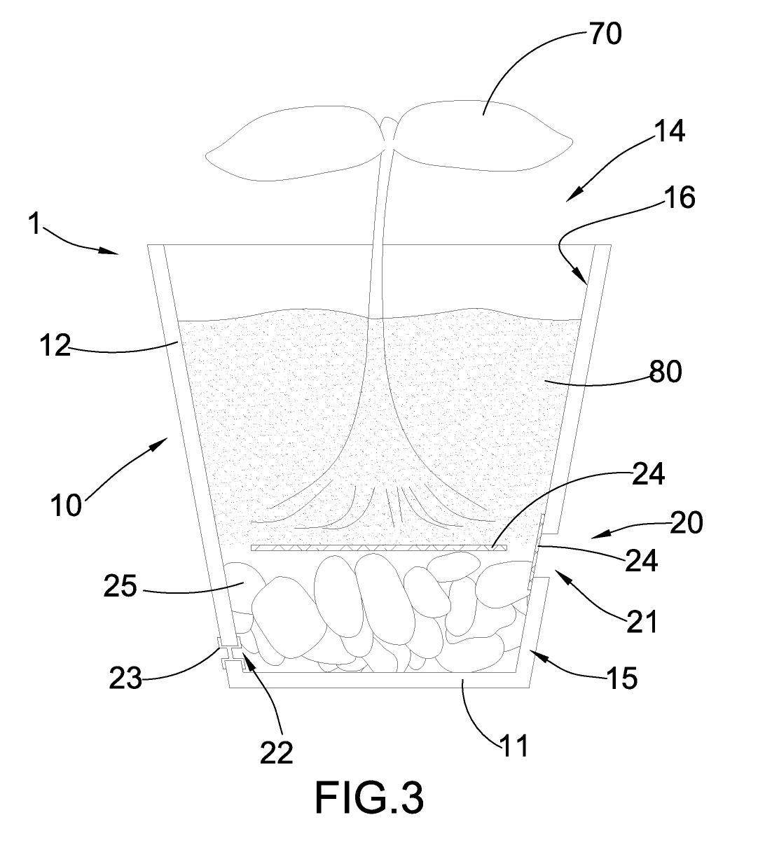

Referring to FIGS. 1 to 3 of the drawings, a flowerpot 1 according a preferred embodiment of the present invention is illustrated. Broadly, the flowerpot 1 may comprise a main body 10, and a water conservation arrangement 20. The flowerpot 1 may be configured and designed for growing plants 70. Thus, a certain amount of soil 80 may be disposed in the main body 10 for providing nutrients to the plant 70.

The main body 10 may have a bottom wall 11, a sidewall 12 upwardly extended from the bottom wall 11, a receiving cavity 13 formed as a space surrounded by the bottom wall 11 and the sidewall 12, and a top opening 14 communicating the receiving cavity 13 with an exterior of the main body 10.

The water conservation arrangement 20 may comprise a plurality of ventilating holes 21, at least one through drainage hole 22, a control valve 23, and a plurality of selective passage members 24. The plurality of ventilating holes 21 may be formed on a lower portion 15 of the main body 10. The through drainage hole 22 may be formed on the main body 10, preferably also on the lower portion 12 thereof.

The control valve 23 may be provided on the drainage hole 22 for being selectively opened to drain water from the receiving cavity 13 so that water in the receiving cavity 13 may be guided to drain out therefrom through the drainage hole 22 when the control valve 23 is opened.

The plurality of selective passage members 24 may be attached on an inner surface 16 of the main body 10 to completely cover the ventilating holes 21 respectively. Each of the selective passage members 24 may be configured to have a predetermined water permeability and a predetermined air permeability, such that when a predetermined amount of soil 80 and water are disposed in the receiving cavity 13, an optimal amount of water is substantially conserved in the received cavity 13 for an extended period of time for being absorbed by the plant 70.

According to the preferred embodiment of the present invention, the main body 10 may be made of plastic or resin material which is relatively light and non-fragile. The main body 10 may be configured as having a circular cross section when viewed from the top and may have a tapered structure. In other words, a diameter of the main body 10 may be gradually decreasing from the top opening 14 to the bottom wall 11. One skilled in the art may appreciate that the main body 10 may have many different cross-sectional shapes, such as rectangular cross-sectional shape, quadrilateral cross-sectional shape, or hexagonal cross-sectional shape, etc. In any event, however, the flowerpot does not include any water collection basin as in conventional flowerpots.

The ventilating holes 21 of the water conservation arrangement 20 may be spacedly formed on the lower portion 15 of the main body 10. An optimal height of the ventilating holes 21 may be approximately ¼ of the vertical height of the main body 10.

Each of the ventilating holes 21 may be formed on the sidewall 12 of the main body 10. A preferably cross-sectional shape of the ventilating holes 21 is circular cross-sectional shape. However, other cross-sectional shapes are also possible. The purpose of the ventilating holes 21 is to allow passage of air so as to create an essential environment in which the roots of the plant may absorb water and for the plant to grow healthily. At the same time, however, the presence of the ventilating holes 21 may cause water to flow out from there. As a result, the selective passage members 24 are necessary to minimize water loss while at the same time allow sufficient ventilation to the receiving cavity 13 of the main body 10.

Each of the selective passage members 24 may be made from fiber composite material which may have a predetermined water permeability and air permeability. The selective passage members 24 may be configured to have a sheet structure and may be attached on an inner side of the main body 10 to cover the ventilating holes 21 respectively. When the ventilating holes 21 are covered by the selective passage members 24, water and air may still pass through the ventilating holes 21, but at a rate regulated or controlled by the selective passage members 24. In other words, when the selective passage members 24 have covered the ventilating holes 21 respectively, a substantial amount of water may be trapped in the receiving cavity 13. The water trapped in the receiving cavity 13 may be slowly absorbed by the soil 80 and eventually absorbed by the plant 70 grown in the flowerpot 1. The result is that substantial water loss similar to that of the conventional flowerpots may be prevented.

At the same time, since the selective passage members 24 are also air permeable, air may go in and out of the receiving cavity 13 through the ventilating holes 21. This feature is essential in basic gardening because roots needs water as well as ventilation.

The water conservation arrangement 20 may further comprise a plurality of (but at least one) weight members 25 provided in the receiving cavity 13 for increasing the weight of the entire flowerpot. In this preferred embodiment, the weight members 25 may be configured as stones. Other materials may also be possible. For example, the weight members 25 may also be configured as sands, sand bags, and the likes. A material density of the weight members 25 may be greater than that of soil 80 used for growing the plant 70 in the receiving cavity 13.

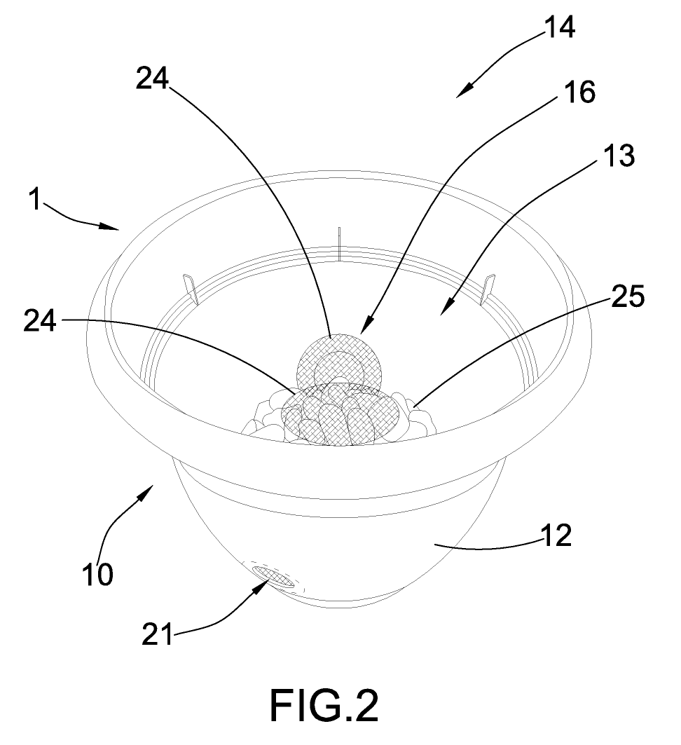

As shown in FIG. 2 of the drawings, the weight members 25 may be disposed to the lower portion 15 of the main body 10. Preferably, a plurality of weight members 25 may be disposed to the main body 10 until a cumulative height of the weight members 25 reaches the ventilating holes 21. However, a cumulative height of the weight members 25 should not be greater than a height of the highest ventilating slot 21. Weight members 25 may secure the foundation of the flowerpot of the present invention, especially when the flowerpot is utilized to grow a plant which is relatively tall. Since the flowerpot is expected to be placed in an outdoor environment, the weight members 25 may help in preventing the flowerpot from being brought down by external forces, such as strong wind.

When the weight members 25 are disposed in the receiving cavity 13 of the main body 10, a selective passage member 24 may be disposed on top of the weight members 25 for partially segregating the weight members 25 and the soil which may then be disposed on top of the weight members 25. The selective passage member 24 disposed on the weight members 25 may have a diameter which is smaller than that of the receiving cavity 13. Preferably, the diameter of the selective passage member 24 which is disposed on the weight members 25 is approximately half of that of the receiving cavity 13.

As shown in FIG. 1 to FIG. 2 of the drawings, the operation of the present invention is as follows: a user may dispose a certain amount of weight members 25 in the receiving cavity 13 until a cumulative height of the weight members 25 reaches the ventilating holes 21. After that, the user may dispose one piece of selective passage member 24 on top of the weight members 24. Finally, a user may dispose a certain amount of soil on top of the weight members 25 and the selective passage member 24 and fill in the remaining space of the receiving cavity 13. After these procedures, the user may start putting his desirable plant in the soil. When water is poured in the flowerpot, the water may be guided to temporarily stay in the lower portion 15 of the main body 10. Since the ventilating holes 21 are covered by the selective passage members 24, water will be substantially prevented from directly flowing out from the ventilating holes 21. At the same time, since the selective passage members 24 are air permeable, air may pass through in and out of the selective passage members 24 and the soil and the roots of the plant will have sufficient ventilation for growing.

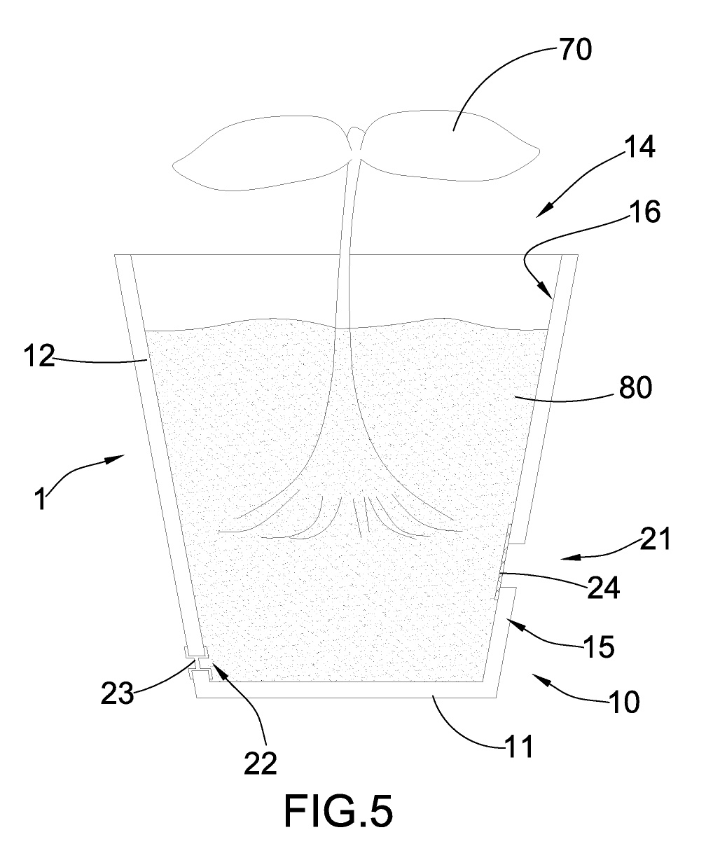

It is worth mentioning that a user may omit the weight members 25 and dispose only the soil in the receiving cavity 13 of the main body 10. This configuration may be suitable for plants 70 having lighter weight or shorter in height so that less secure foundation may be sufficient, as shown in FIG. 5 of the drawings.

The control valve 23 may be configured as a stopper made of plastic or rubber material and which may be selectively inserted into the drainage hole 22 for selectively allowing water from the receiving cavity 13 from being drained out thereof. In certain weather conditions, water in the receiving cavity 13 may needs to be drained out therefrom to prevent the roots of the plant 70 from immersing in too much water.

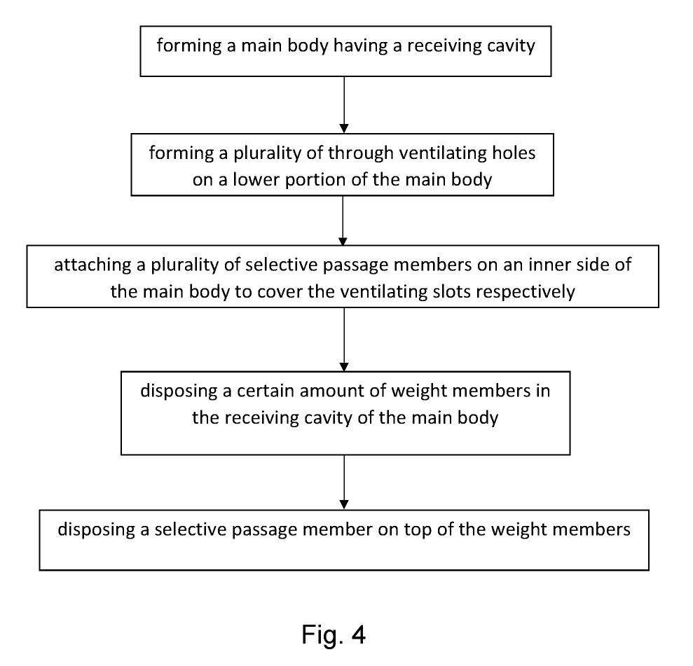

Referring to FIG. 4 of the drawings, a method of making a flowerpot according to the preferred embodiment of the present invention is illustrated. The method may comprise the steps of:

(a) forming a main body 10 having a receiving cavity 13, the main body 10 having a bottom wall 11, a sidewall 12 upwardly extended from the bottom wall 11, a receiving cavity 13 formed as a space surrounded by the bottom wall 11 and the sidewall 12, and a top opening 14 communicating the receiving cavity 13 with an exterior of the main body 10;

(b) forming a plurality of through ventilating holes 21 on a lower portion 15 of the main body 10;

(c) attaching a plurality of selective passage members 24 on an inner side of the main body 10 to cover the ventilating slots 21 respectively;

(d) disposing a certain amount of weight members 25 in the receiving cavity 13 of the main body 10, a cumulative height of the weight members 25 not exceeding a height of the highest ventilating slots 21; and

(e) disposing a selective passage member 24 on top of the weight members 25.

The present invention, while illustrated and described in terms of a preferred embodiment and several alternatives, is not limited to the particular description contained in this specification. Additional alternative or equivalent components could also be used to practice the present invention.

What is claimed is:

1. A flowerpot for a plant, comprising:
a main body having a bottom wall, a sidewall upwardly extended from said bottom wall, a receiving cavity formed as a space surrounded by said bottom wall and said sidewall, and a top opening communicating said receiving cavity with an exterior of said main body; and
a water conservation arrangement, which comprises:
a plurality of ventilating holes formed on a lower portion of said main body;
at least one through drainage hole formed on said main body;
a control valve provided on said drainage hole for being selectively opened to drain water from said receiving cavity; and
a plurality of selective passage members attached on said main body to completely cover said ventilating holes respectively, each of said selective passage members being configured to have a predetermined water permeability and a predetermined air permeability,
wherein when a predetermined amount of soil and water are disposed in said receiving cavity, said water is substantially conserved in said received cavity for being absorbed by said plant.

2. The flowerpot, as recited in claim 1, wherein said water conservation arrangement further comprises a plurality of weight members provided in said receiving cavity for increasing said weight of said entire flowerpot.

3. The flowerpot, as recited in claim 2, wherein said a selective passage member is arranged to be disposed on top of said weight members for partially segregating said weight members and said soil which is disposed on top of said weight members.

4. The flowerpot, as recited in claim 2, wherein said ventilating holes of said water conservation arrangement are spacedly formed on said lower portion of said main body at a height which is approximately one-fourth of said vertical height of said main body.

5. The flowerpot, as recited in claim 3, wherein said ventilating holes of said water conservation arrangement are spacedly formed on said lower portion of said main body at a height which is approximately one-fourth of said vertical height of said main body.

6. The flowerpot, as recited in claim 4, wherein each of said selective passage members is made from fiber composite material which may have a predetermined water permeability and air permeability.

7. The flowerpot, as recited in claim 5, wherein each of said selective passage members is made from fiber composite material which may have a predetermined water permeability and air permeability.

8. The flowerpot, as recited in claim 6, wherein said weight members are arranged to be disposed to said lower portion of said main body until a cumulative height of said weight members reaches said ventilating holes, a cumulative height of said weight members not exceeding a height of said highest ventilating slot.

9. The flowerpot, as recited in claim 7, wherein said weight members are arranged to be disposed to said lower portion of said main body until a cumulative height of said weight members reaches said ventilating holes, a cumulative height of said weight members not exceeding a height of said highest ventilating slot.

10. The flowerpot, as recited in claim 1, wherein each of said selective passage members is configured to have a sheet structure and attached on an inner surface of said main body at said corresponding ventilating hole.

11. The flowerpot, as recited in claim 8, wherein each of said selective passage members is configured to have a sheet structure and attached on an inner surface of said main body at said corresponding ventilating hole.

12. The flowerpot, as recited in claim 9, wherein each of said selective passage members is configured to have a sheet structure and attached on an inner surface of said main body at said corresponding ventilating hole.

13. The flowerpot, as recited in claim 9, wherein said weight members are configured as stones.

14. The flowerpot, as recited in claim 12, wherein said weight members are configured as stones.

15. The flowerpot, as recited in claim 1, wherein said main body is made of one of plastic material and resin material.

16. The flowerpot, as recited in claim 2, wherein said main body is made of one of plastic material and resin material.

17. The flowerpot, as recited in claim 12, wherein said main body is made of one of plastic material and resin material.

18. A method of making a flowerpot, comprising the steps of:
(a) forming a main body having a receiving cavity, said main body having a bottom wall, a sidewall upwardly extended from said bottom wall, a receiving cavity formed as a space surrounded by said bottom wall and said sidewall, and a top opening communicating said receiving cavity with an exterior of said main body;
(b) forming a plurality of through ventilating holes on a lower portion of said main body;
(c) attaching a plurality of selective passage members on an inner side of said main body to cover said ventilating slots respectively;
(d) disposing a certain amount of weight members in said receiving cavity of said main body, a cumulative height of said weight members not exceeding a height of said highest ventilating slots; and
(e) disposing a selective passage member on top of said weight members.

19. The method, as recited in claim 18, wherein each of said selective passage members is made from fiber composite material which may have a predetermined water permeability and air permeability.

20. The flowerpot, as recited in claim 19, wherein said main body is made of one of plastic material and resin material.
